(19) United States
(12) Patent Application Publication
(10) Pub. No.: US 2011/0300932 A1
(43) Pub. Date: Dec. 8, 2011

(54) INTERACTIVE DISPLAY AND USE THEREOF

(76) Inventor: Byron M. Henderson, New York, NY (US)

(21) Appl. No.: 12/872,188

(22) Filed: Aug. 31, 2010

Related U.S. Application Data
(63) Continuation-in-part of application No. 12/134,140, filed on Jun. 5, 2008.
(60) Provisional application No. 60/942,052, filed on Jun. 5, 2007.
(60) Provisional application No. 61/022,136, filed on Jan. 18, 2008.

(51) Int. Cl. A63F 13/00; A63F 9/24; A63F 13/06

(52) U.S. Cl. 463/30; 463/37; 463/43

(57) ABSTRACT

For a playing experience in a computer game that more accurately captures the experience of professional football or another sport, it is advantageous to be able to hide from an opponent a selected player formation and play selection until the play actually begins. Similarly, in other computer games such as war games and role-playing games, it is desirable to be able to hide from other players certain properties—e.g., equipment, disposition of forces, etc.—held by each player while making this information available to the player holding these properties. In the present invention, display devices are provided that are visible only to a limited number of players. Illustratively, the display device can be worn on the player's forearm. Information that would typically be hidden from the other side in a real situation is made available to only one side by displaying it on one of these display devices.

### CROSS-REFERENCE TO RELATED APPLICATIONS

This application is a continuation-in-part of application Ser. No. 12/134,140, filed Jun. 5, 2008, which claims benefit of provisional application Ser. No. 60/942,052, filed Jun. 5, 2007, and Ser. No. 61/022,136, filed Jan. 18, 2008, all of which are hereby incorporated by reference in their entirety.

### FIELD OF THE INVENTION

This relates to interactive displays and their use. It is particularly useful in computer gaming and will be described in that context.

### BACKGROUND OF THE INVENTION

In a conventional multi-player computer game, a game console such as a Playstation, Xbox, Gamecube or Wii is connected to a television set and individual player controllers are connected to the game console. In this arrangement, each player sees everything displayed on the television screen. For a playing experience that more accurately captures the experience of professional football or another sport, it would be advantageous to be able to hide from an opponent a selected player formation and play selection until the play actually begins. Similarly, in other computer games such as war games and role-playing games, it is desirable to be able to hide from other players certain properties—e.g., resources, equipment, disposition of forces, etc.—held by each player while making this information available to the player holding these properties. At the same time, any secrecy that is achieved should not detract from the playability of the game and should make efficient use of display screen resources.

In still other games, the amount of information that is provided to a player may be limited by the size of the television screen. For example, in conventional games that include a simulated cockpit such as in automobile racing or airplane flying, the television screen is used both to provide a simulated view of the exterior through a windshield and to provide a simulated view of the cockpit instruments. Unfortunately, the limited size of the television screen often means that either, or both, of the exterior view and the cockpit view must be reduced in scope.

### SUMMARY OF THE INVENTION

In an illustrative embodiment of the present invention, display devices are provided that are visible only to individual players. One such embodiment of the display device comprises a display screen, a control button, a connector, a power switch and an LED signal light mounted on a frame. Some embodiments are intended to be mounted on a player's forearm by suitable means such as straps.

In a further illustrative embodiment of the invention, a plurality of these display devices is operated so that information that is to be hidden from a second side in a video game is made available to the first side on a first of these display devices; and information that is to be hidden from the first side is made available to the second side on a second of these display devices. Specifically, software is provided for selectively displaying on one or more such display devices first information that is intended to be seen by only a first group of players and for selectively displaying on other such display devices second information that is intended to be seen by only a second group of players while inhibiting the display of the first and second information to all players in common. For example, in the case of a football game, the software prevents the display of player formation and play selection screens for both teams to all players in common but provides to one opponent's display device player formation and play selection information for his team and to the other opponent's display device the player formation and play selection information for his team.

In another illustrative embodiment of the invention, a display device is used to expand the information that is provided to a player and/or to provide better simulation of the gaming environment. For example, in games that include a simulated cockpit, a simulation of the cockpit instrument panel may be displayed on one or more small display devices while a simulation of the exterior through a windshield may take up the full screen of a television display.

The invention also includes software fixed in a suitable recording medium such as a CD or DVD that includes instructions executable by a computer processor for controlling the game console, the display devices and the television to display the appropriate images.

### BRIEF DESCRIPTION OF THE DRAWINGS

These and other objects, features and advantages of my invention will be more readily apparent from the following Detailed Description in which:

FIG. 1 is a perspective view an illustrative embodiment of the display device of the invention;

FIG. 2 is a block diagram of the circuitry of the display device of FIG. 1;

FIG. 3 is a flowchart depicting certain operations of the display device of FIG. 1

FIGS. 4 and 5 are illustrations of television player formation and play selection screens of the prior art;

FIGS. 6-9 are illustrations of play call screens that might be seen on the display device of FIG. 1;

FIGS. 10 and 11 are illustrations of television play call screens that might be used with the display device of FIG. 1; and

FIG. 12 is a flowchart depicting certain operations of an illustrative example of software utilizing the display device of FIG. 1.

### DETAILED DESCRIPTION

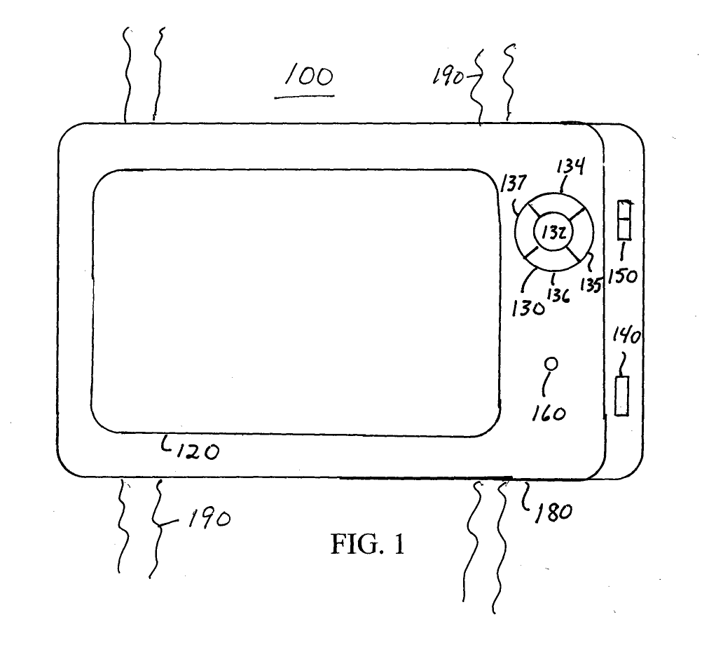

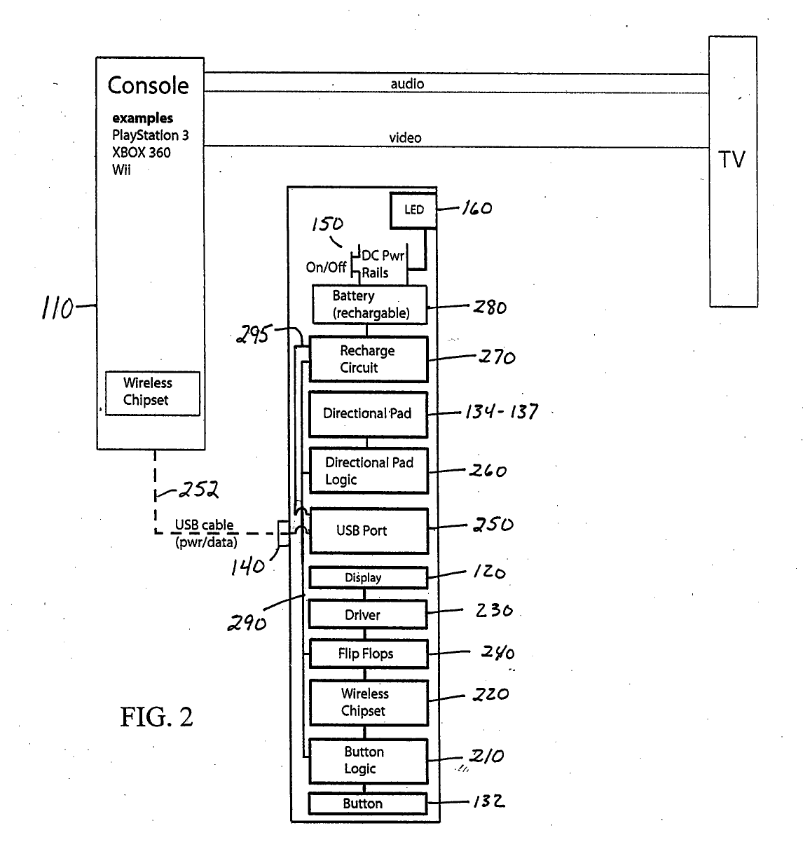

FIG. 1 is a perspective view of a display device 100 of an illustrative embodiment of the invention. Preferably, each player has his own display device 100 and, in one embodiment of the invention, each display device is connected to a gaming console 110 as shown in FIG. 2. Display device 100 comprises a display screen 120, a control button 130, a connector 140, a power switch 150, and an LED signal light 160 mounted on a frame 180. Illustratively, frame 180 measures approximately 2.5 to 5 inches in height and approximately 4 to 8 inches in length; but other size frames may also be used. The frame is intended to be mounted on a player's forearm by straps 190; but numerous other mounting arrangements may be used instead. For example, the frame may be secured to a padded sleeve that is slipped over the player's hand and forearm.

Illustratively, display screen 120 is a high visibility light emitting diode (LED) display screen. Illustratively, control button 130 has a central button 132 and four peripheral buttons 134, 135, 136, 137, each occupying one of the four North, East, South, and West quadrants around the central button 132. The four peripheral buttons control directional movement (up, right, down, and left, respectively) of objects on the display screen. The central button is a selection button. Power switch 150 is used to turn display device 110 on and off and LED light 170 indicates whether the display device is on or off. Other control buttons may also be mounted on frame 180. Alternatively, some or all of the buttons may be implemented as touch screen buttons or other commands on display screen 120. In this alternative, the display screen may be expanded to encompass substantially all of the upper surface of frame 180. Illustratively, connector 140 is a USB 2.0 connector or equivalent with signal, power and ground lines for connecting display device 100 to console 110. In other embodiments, the display devices may be connected to a computer; and connector 140 may provide signal, power and ground lines for such connections.

Electronics for controlling display screen 120 and button 130 and for managing connector 140 are enclosed within frame 180. FIG. 2 is a block diagram of these electronics and their connection to the elements of FIG. 1. The electronics comprises button logic 210 for reading central button 132, a wireless chipset 220 for communicating with console 110, a display driver 230 for driving display screen 120, flip-flops 240 for storing display signals for supply to display driver 230, a USB port 250 connected by a USB cable 252 to console 110 via connector 140, directional pad logic 260 connected to buttons 134-137, a battery charging circuit 270, and a battery 280. Power switch 160 and LED light 170 are connected to the power rails. A signal bus 290 interconnects button logic 210, flip-flops 240, USB port 250, directional pad logic 260 and charging circuit 270. A power bus 295 connects USB port 250 to charging circuit 270.

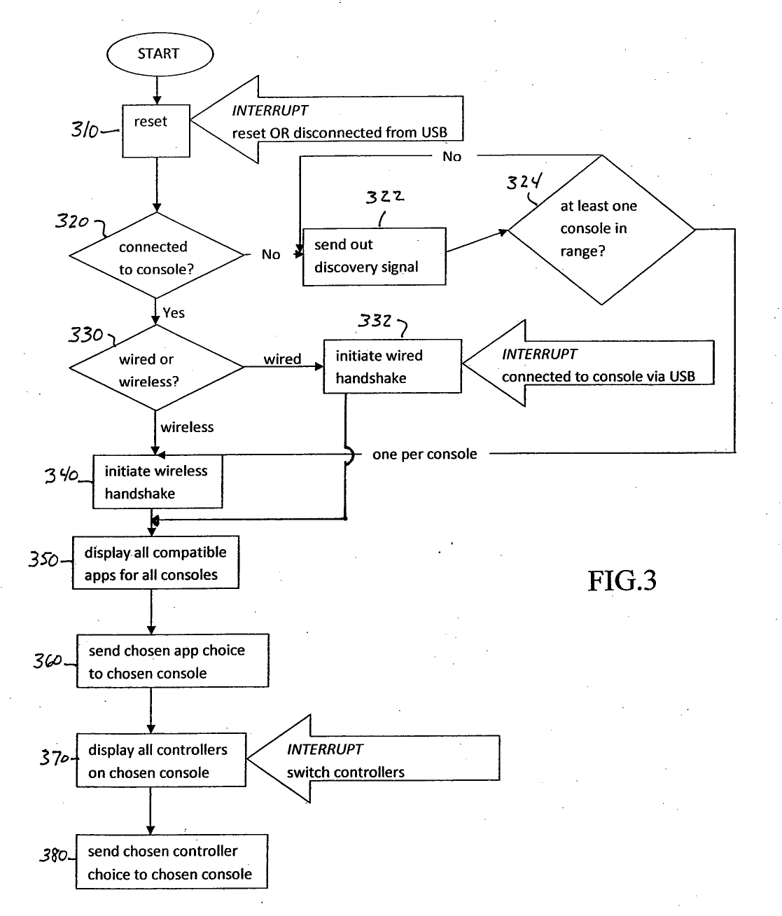

FIG. 3 is a flowchart that depicts the initialization of display device 100 following the time it is turned on by power switch 160. The device begins by resetting at step 310. Following reset, at step 320 the device tests to determine if it is connected to a console. If not, it sends out a discovery signal at step 322; and tests at step 324 if at least one console is within range. If none is, it continues to send out a discovery signal. If a console is within range, the device proceeds to step 340 discussed below. If the controller is connected to a console, the device tests at step 330 if the connection is by wire or wireless. If it is wired, the device initiates a wired handshake at step 332. If it is connected by wireless, it initiates a wireless handshake at step 340. Following completion of the handshake process at either step 332 or 340, a display is generated on display screen 120 at step 350 of all compatible applications that are available on all consoles to which the display device is connected. At step 360, a selection is made of one of these applications by scrolling through a list of the applications and the selection is transmitted to the selected console. At step 370, the controllers connected to the chosen console are displayed on the display device. Finally, at step 380, a selection is made of one of the controllers by scrolling through a list of controllers; and that selection is forwarded to the chosen console.

As noted above, in many multi-player computer games, it may be desirable to limit the display of certain information to one of the players so that his opponent(s) cannot see that information. For example, in various sports games such as Madden '11 and similar games, the offensive and defensive players have the opportunity to select both their team's formation and a particular play. In commercially available versions of these games, this is done with each player knowing the other player's selected formation and which plays are available for selection since they are displayed on the television screen in front of him.

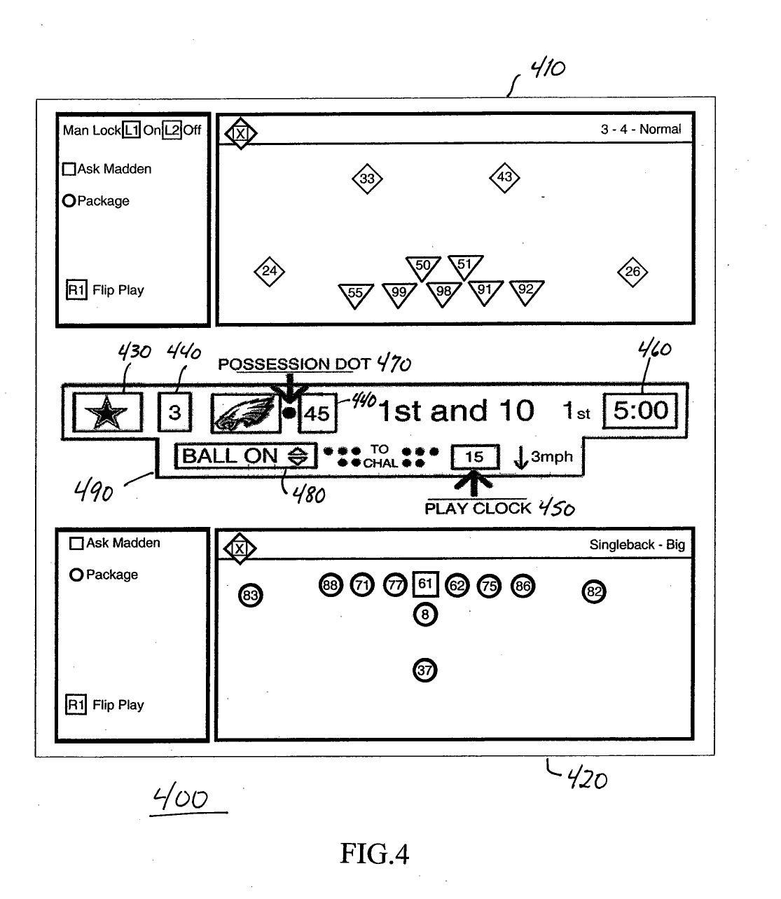

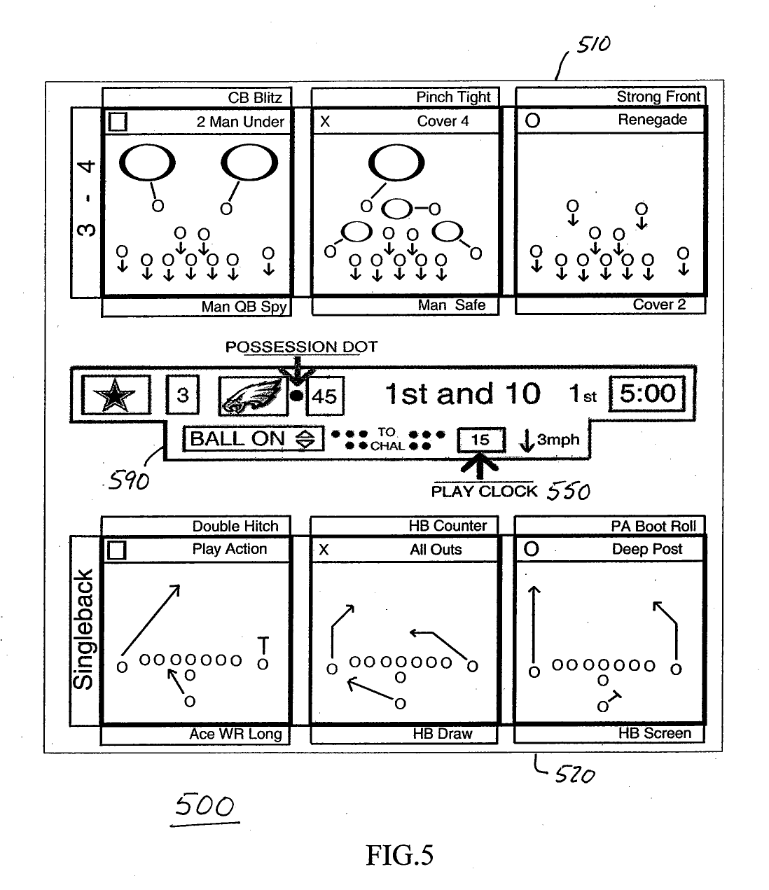

For example, FIGS. 4 and 5 depict the general format of the offensive and defensive player formation selection screens 400 and play selection screens 500 in Madden '11. Formation selection screen 400 comprises upper and lower formation selection boxes 410 and 420 and scoreboard 490 in between. Play selection screen 500 is similar and comprises upper and lower play selection boxes 510 and 520 and scoreboard 590 in between. In FIG. 4, the defensive player formations are shown at the top in box 410 and the offensive player formations are shown at the bottom in box 420. Scoreboard 490 displays logos 430 or other indicia representative of the teams (in this case, Cowboys and Eagles), score boxes 440, a play clock 450, a game clock 460, a possession dot 470 indicating which team has the ball, and a yard marker 480. Each player selects one of the player formations displayed in boxes 410 or 420 by scrolling through a series of possible formations and clicking a button or operating a similar selection mechanism on his controller when he reaches the desired formation. FIG. 4 depicts the display for selection of a 3-4 defensive formation and a singleback offensive formation.

When the formation is selected, multiple plays from that formation are then presented to the player and the player then selects one of these plays to run. The defensive player's play selections are shown at the top of FIG. 5 in box 510 and the offensive player's play selections are shown at the bottom in box 520. Scoreboard 590 contains the same elements as scoreboard 490 with the element numbers incremented by 100. FIG. 5 depicts the display for selection of three plays from the 3-4 defensive formation and three plays from the singleback offensive formation. The play clock 550 specifies the offensive player's time to select a play. If he fails to select a play in the specified time, a delay of game penalty results. The defensive player has an additional 10 seconds after the offensive player selects a play to select a defensive play. The defensive player's time to make a selection is also displayed by play clock 550. If the defensive player fails to select a defensive play in 10 seconds, the most recent defensive play is repeated.

Unfortunately, this arrangement is not very realistic. In a real professional football game, both the offensive and the defensive teams go to considerable effort to hide their formations and play selection. Teams use multiple offensive formations and the play that is selected is typically done so in secrecy in the huddle. It may also be changed one or more times before the ball is snapped. Similarly, teams use multiple defensive formations and go to considerable effort to obscure their intentions before the ball is snapped.

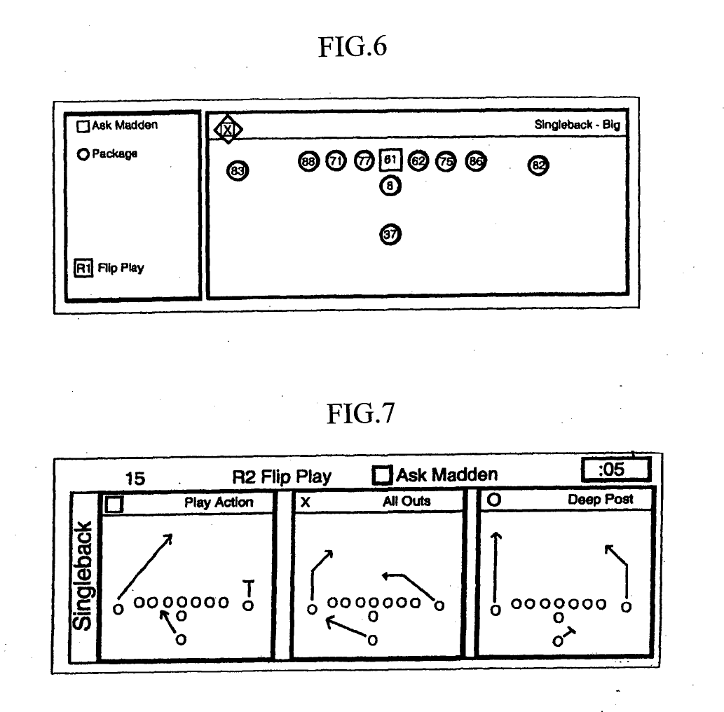

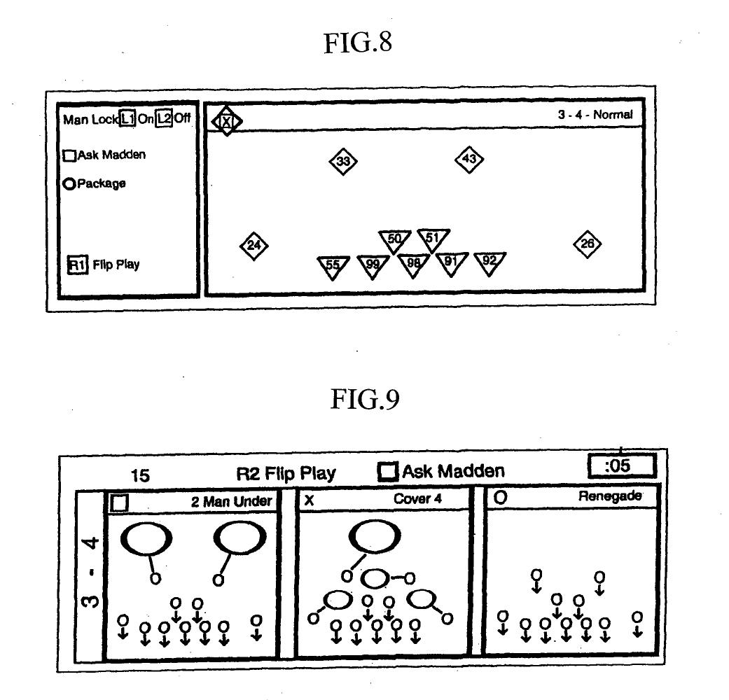

In accordance with the invention, each player's formation selection and play selection are done without the knowledge of the other player using display devices 100 instead of the television screen to display the formation selection and play selection boxes. FIGS. 6 and 7 depict illustrative examples of the offensive player's formation selection and play selection boxes that are presented on a first display device 100 of the present invention; and FIGS. 8 and 9 depict illustrative examples of the defensive player's formation selection and play selection boxes that are presented on a second display device 100. Using his own display device, each player scrolls through a series of possible player formations until he selects one; and then he selects one of several possible plays from that formation. FIGS. 6 and 8 depict the singleback offensive formation and the 3-4 defensive formation, respectively, at the time of their selection. FIGS. 7 and 9 depict three plays that may be selected from the singleback offensive formation and three plays that may be selected from the 3-4 defensive formation.

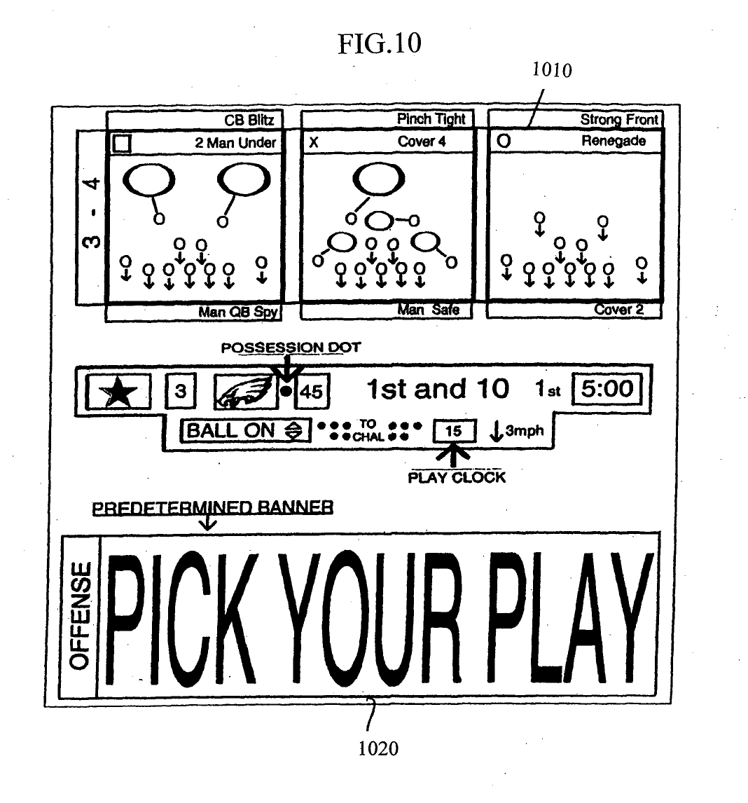

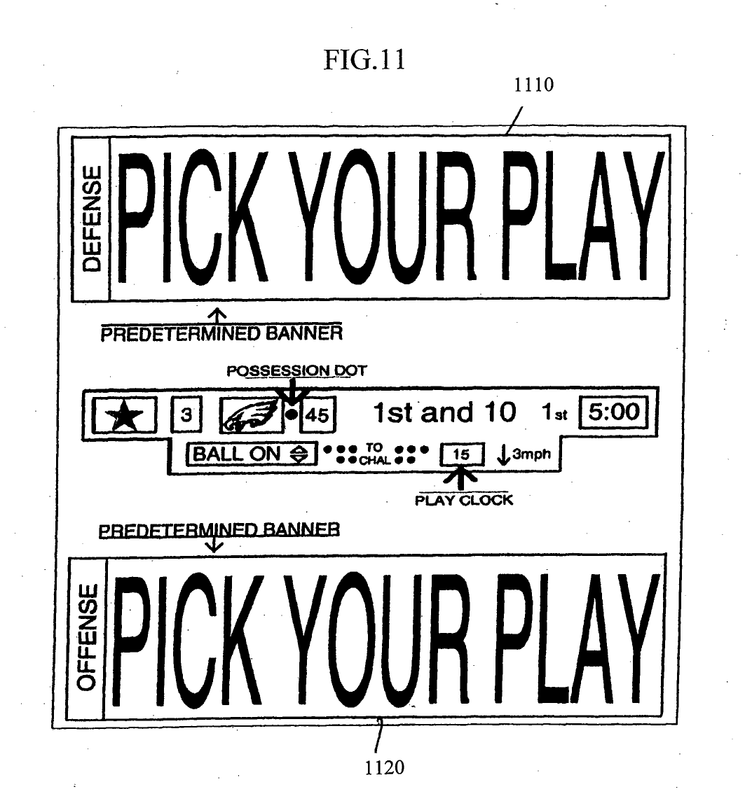

Advantageously, the formation selection and play selection information selectively displayed to the offensive player and the defensive player is the same information that is obscured from any display that is shared in common such as a television screen. For example, FIGS. 10 and 11 depict illustrative examples of alternative play call screens 1000, 1100 that are displayed on a television screen when formation selection and play selection information is displayed on individual display devices in accordance with the invention. In contrast to the prior art displays of FIGS. 4 and 5, in FIG. 10 the offensive player's formation selection and play selection have been obscured in box 1020. In like fashion, the defensive player's formation selection and play selection can be obscured in box 1010. In FIG. 11, both players' formation selections and play selections have been obscured in boxes 1110 and 1120. As a result, one or both players must select his formation and play without information about his opponent's formation and play.

This arrangement also facilitates further modifications of the play call screen such that the players can change their plays at any time up until the ball is snapped. In particular, players can change their selected plays as is frequently done by the quarterback though audibles, coverage assignments for various players can be changed, and the position of various players can also be changed.

As will be appreciated, this arrangement is much more realistic in its treatment of the game.

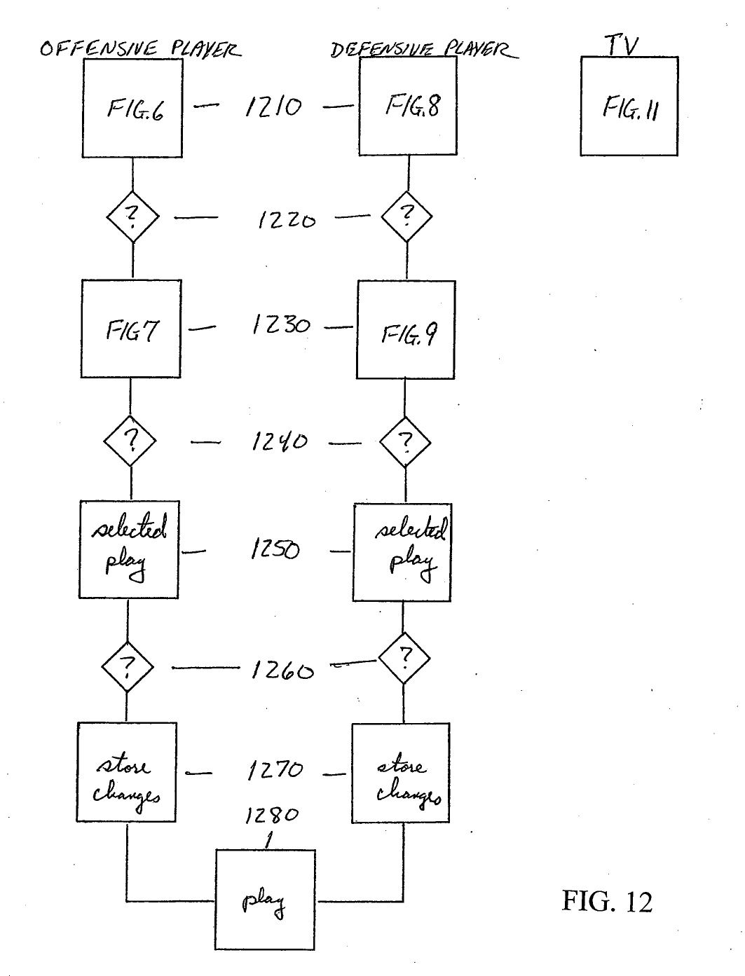

FIG. 12 is a flowchart depicting the operation of certain portions of the software for generating the player formation and play selection boxes on display devices 100. For this example, it is assumed that there are multiple players on each side, each player having his or her own display device 100. The flowchart begins at the point where player formation information is presented to the players and describes the software flow for control of the display on the television screen, the display on the display devices used by the offensive players and the display on the display devices used by the defensive players. Prior to this point, the television screen would have been displaying information of general interest to both teams of players such as the execution of the previously selected play and the spotting of the football at its new position on the playing field.

At step 1210, a screen such as that depicted in FIG. 11 is presented on the television screen; a player formation selection screen such as that depicted in FIG. 6 is presented on the offensive players' display devices; and a player formation selection screen such as that shown in FIG. 8 is presented on the defensive players' display devices. Thus, the player formation selection information is blocked on the television screen that is visible to both sides; and the player formation selection information that is provided for each side is provided only to the display devices associated with that side. The play clock begins to count down on the television screen and the individual players' display devices. Illustratively, the offensive players are given 25 seconds to select and initiate a play. If the offensive players fail to get the play off in time, the offensive team receives a delay of game penalty.

The offensive players select a player formation by scrolling through a series of offensive player formations displayed on the display screens 120 of their display devices 100. The defensive players do the same with a series of defensive player formations displayed on the display screens of their display devices. The offensive players' display devices and the defensive players' display devices are monitored at step 1220 for selection of specific player formations. When it is noted that one side has selected a player formation, at step 1230 the player formation is stored; and a play selection screen that depicts several plays for that player formation is displayed on the display screens of that side's display devices. Thus, a play selection screen such as that depicted in FIG. 7 is displayed on the offensive players' display devices; and a play selection screen such as that shown in FIG. 9 is displayed on the defensive players' display devices. The offensive players' display devices continue to be monitored at step 1240 for timely selection and initiation of a play. Likewise, the defensive players' display devices are monitored for selection of the defensive play.

After the plays have been selected but before the play is initiated, the selected offensive play is displayed at step 1250 on the display devices of the offensive players; and the selected defensive play is displayed on the display devices of the defensive players. The offensive players' display devices and the defensive players' display devices are monitored at step 1260 for any audibles that may be entered that change the play and/or pre-snap adjustments in player assignments, coverage or player position. Thus, the offensive display devices are continually tested at step 1260 for any change of play or pre-snap adjustment; and any change or adjustment is stored at step 1270. Similarly, the defensive display devices are continuously tested at step 1260 for any change of play or pre-snap adjustment; and any change or adjustment is stored at step 1270. When the offensive players decide to, one of them initiates the play; and the offensive and defensive plays currently stored are executed at step 1280. If a defensive play has not been selected, the defensive play used in the previous play is used again. Play then returns to normal operation of the game.

Pseudo-code for the operation of the steps of FIG. 12 is set out below. Appropriate software instructions that may be executed by one or more computer processors to perform the steps of FIG. 12 will be evident from the pseudo-code.

PLAY CALL SCREEN (play call)

```
for each user wearing a display device{
  if this user is on offense{
    if the offensive playbook area on the TV screen has not
    been obscured{
    obscure the offensive playbook area on the TV screen
  }
  send the offensive formations to the user's display device
  }
  else if this user is on defense{
    if the defensive playbook area on the TV screen has
    not been obscured{
      obscure the defensive playbook area on the TV screen
    }
    send the defensive formations to the user's display device
  }
}
Comment: one user on offense selects an offensive formation
while one user on defense selects a defensive formation
(all formations are shown on the respective display devices)
for each user wearing a display device{
  if this user is on offense{
  send the offensive plays for the selected formation to the
  user's display device
  }
  else if this user is on defense{
  send the defensive plays for the selected formation to the
  user's display device
  }
}
Comment: one user on offense selects a play for the selected
offensive formation while one user on defense selects a play
for the selected defensive formation (all plays are shown
on the respective display devices)
for each user wearing a display device{
  clear the user's display device screen
}
Comment: go to the play run screen
```

PLAY CALL SCREEN (suggested play)

```
if a user requests a suggested play {
  for each user, on the suggested play-requesting team, wearing
  a display device{
    highlight the suggested play on the user's display device
    (no change to television screen)
  }
}
```

PLAY RUN SCREEN (pre-snap audible)

```
if a user calls an audible{
  for each user, on the audible-calling team, wearing a display device{
    if this user is on offense {
      send the offensive formations to the user's display device
      (no change to television screen)
    }
    else if this user is on defense{
      send the defensive formations to the user's display device
      (no change to television screen)
    }
  }
}
Comment: one user, on the audible-calling team, selects an
offensive or defensive formation (all formations are shown on the
respective display devices)
for each user, on the audible-calling team, wearing a display device{
  if this user is on offense{
    send the offensive plays for the selected formation to the user's
    display device
      (no change to television screen)
  }
  else if this user is on defense{
    send the defensive plays for the selected formation to the user's
    display device
      (no change to television screen)
  }
}
Comment: one user, on the audible-calling team, selects an
offensive or defensive play for the selected formation (all plays are
shown on the respective display devices)
for each user, on the audible-calling team, wearing a display device{
  clear the user's display device screen
}
Comment: reposition offensive or defensive players on
the television screen based on the chosen audible play
```

PLAY RUN SCREEN (pre-snap reassignment audible)

```
if a user calls an assignment audible{
  for each user, on the audible-calling team, wearing a display device{
    if this user is on offense{
      send an image depicting all of the offensive players
      eligible for passing,
      blocking, or running route reassignment to the user's
      display device
      (no change to television screen)
    }
    else if this user is on defense{
      send an image depicting all of the defensive players
      eligible for blitzing,
      blocking, or coverage reassignment to the user's display device
      (no change to television screen)
    }
  }
}
Comment: one user, on the audible-calling team, selects
players from the image, shown on the respective display devices, of
offensive or defensive players eligible for reassignment
for each user, on the audible-calling team, wearing a display device{
  clear the user's display device screen
}
for each user, on the audible-calling team, wearing a display device{
  if this user is on offense{
    send an image, to the display device, of all offensive passing,
    blocking, or running route reassignment s for the selected player(s)
  }
  else if this user is on defense{
    send an image, to the display device, of all defensive blitzing,
    blocking, or coverage reassignments for the selected player(s)
  }
}
Comment: one user, on the audible-calling team, selects an offensive
or defensive reassignment from the image shown on the respective
display devices for each user, on the audible-calling team, wearing a
display device{
  clear the user's display device screen
}
```

PLAY RUN SCREEN (coach's cam)

```
if a user views the coach's cam{
  if this user is on offense{
    send an image of all of the current offensive passing,
    blocking, or running routes to the user's display device
    (no change to television screen)
  }
  else if this user is on defense{
    send an image of all of the current defensive blitzing, blocking, or
    coverage assignments to the user's display device
    (no change to television screen)
  }
}
Comment: if the user viewing the coach's cam stops viewing,
clear the user's display device screen
```

The invention may be practiced in numerous competitive situations where it is desirable to conceal some or all of a display from one or more competitors. In addition to sports, the invention may also be practiced with computer war games and role-playing games where it is desirable to hide from other players certain properties such as resources, equipment, disposition of forces, etc. while making this information readily available to the player holding these properties. Thus, each player may be equipped with a small display device controlled by software that displays on the device only information about that player's resources, etc. and does not make the information available to other players.

The invention may also be practiced so as to provide multiple displays of information to a player and thereby expand the amount of information that is provided and/or provide a better simulation to the gaming environment. For example, in games that include a simulated cockpit such as in automobile racing or airplane flying, one display such as a television screen might simulate a view of the exterior through a windshield while a second display on a display device 100 might simulate a view of a cockpit display with indications such as speed, rpm, gear and fuel in the case of auto racing and speed, altitude, roll, pitch, yaw and fuel in the case of airplane flying. Again, where multiple players are competing against one another, different information may be displayed on different display devices 100 to simulate each player's performance in the game while also keeping some or all of such information from his competitors.

Numerous variations may be practiced in the foregoing apparatus and methods within the spirit and scope of the invention.

What is claimed is:

1. A method for controlling at least first, second and third displays on which are depicted components of a gaming contest between at least first and second competing entities comprising;
displaying on the first display visible to both competing entities information of a general interest;
displaying on the second display visible to the first competing entity but not the second competing entity information of interest to the first competing entity that should not be seen by the second competing entity; and
displaying on the third display visible to the second competing entity but not the first competing entity information of interest to the second competing entity that should not be seen by the first competing entity.

2. The method of claim 1 wherein the second and third displays are small screen displays visible only to a limited audience.

3. The method of claim 1 wherein each of the second and third displays comprises a display screen, a power supply for supplying power to the display screen, a selection switch for interacting with information that is displayed on the display screen, and a connection for connecting the display screen to a game console.

4. The method of claim 1 wherein the gaming contest is a football game, the first and second competing entities are controlling different teams in the football game, and the information that would be detrimental to the first competing entity if seen by the second competing entity is information concerning selection of player formations.

5. The method of claim 1 wherein the gaming contest is a football game, the first and second competing entities are controlling different teams in the football game, and the information that would be detrimental to the first competing entity if seen by the second competing entity is information concerning selection of plays.

6. The method of claim 1 wherein the gaming contest is a war game or role-playing game, the first and second competing entities are controlling different sides in the war or role-playing game, and the information that would be detrimental to the first competing entity if seen by the second competing entity is information concerning resources, equipment, or disposition of forces.

7. A method of playing a video game between at least first and second competing entities comprising the steps of:
generating successive frames of a video signal depicting the video game;
displaying certain frames of the successive frames on a first display that is visible to both competing entities;
displaying information that is not to be made available to the second competing entity on a second display that is visible to the first competing entity but not the second competing entity; and
displaying information that is not to be made available to the first competing entity on a third display that is visible to the second competing entity but not the first competing entity.

8. The method of claim 7 wherein the second and third displays are visible only to a limited audience.

9. The method of claim 7 wherein each of the second and third displays comprises a display screen, a power supply for supplying power to the display screen, a selection switch for interacting with information that is displayed on the display screen, and a connection for connecting the display screen to a game console.

10. The method of claim 7 wherein the successive frames of the video signal depict a game having at least two competing players and the information that is not to be provided to one of the competing entities is a selection of plays being made available to another of the competing entities.

11. The method of claim 7 wherein the video game is a football game, the first and second competing entities are controlling different teams in the football game, and the information that is not to be made available to the first competing entity is information concerning selection of player formations by the second competing entity.

12. The method of claim 7 wherein the video game is a football game, the first and second competing entities are controlling different teams in the football game, and the information that is not to be made available to the first competing entity is information concerning selection of plays by the second competing entity.

13. The method of claim 7 wherein the video game is a war game or role-playing game, the first and second competing entities are controlling different sides in the war or role-playing game, and the information that is not to be made available to the first competing entity is information concerning resources, equipment or disposition of forces of the second competing entity.

14. The method of claim 7 wherein the video game includes cockpit displays for first and second competing players and the information that is not to be made available to the first competing entity is information displayed on the cockpit display of the second competing entity.

15. Software fixed in a recording medium comprising instructions executable by one or more computer processors for controlling at least first, second and third displays on which are depicted components of a gaming contest between at least first and second competing entities, said software comprising instruction for:
displaying on the first display visible to both competing entities information of a general interest;
displaying on the second display visible to the first competing entity but not the second competing entity information of interest to the first competing entity that should not be seen by the second competing entity; and
displaying on the third display visible to the second competing entity but not the first competing entity information of interest to the second competing entity that should not be displaying on the first display visible to both competing entities information of a general interest.

16. The software of claim 15 wherein the gaming contest is a football game, the first and second competing entities are controlling different teams in the football game, and the information that would be detrimental to the first competing entity if seen by the second competing entity is information concerning selection of player formations and/or selection of plays.

17. A display device for displaying information generated by a gaming console comprising:
a display screen for displaying information generated by the gaming console;
a power supply for supplying power to the display screen;
a selection switch for interacting with information that is displayed on the display screen;
a connection for connecting the display screen to the gaming console so as to display on the screen information generated by the gaming console; and
a mounting for securing the display device to a forearm of a player of a game that is generated by the gaming console.

18. The display device of claim 17 wherein the connection is a wireless connection.

19. The display of claim 17 wherein the display is shorter than the player's forearm.
